(19) United States
(12) Patent Application Publication
(10) Pub. No.: US 2012/0204047 A1
(43) Pub. Date: Aug. 9, 2012

(54) APPARATUS AND METHODS FOR PROCESSOR POWER SUPPLY VOLTAGE CONTROL USING PROCESSOR FEEDBACK

(75) Inventor: Jae Kwan Ryoo, Suwon-si (KR)

(73) Assignee: Samsung Electronics Co., Ltd.

(21) Appl. No.: 13/237,804

(22) Filed: Sep. 20, 2011

(30) Foreign Application Priority Data
Feb. 7, 2011 (KR) 10-2011-0010483

(51) Int. Cl. G06F 1/32

(52) U.S. Cl. 713/323

(57) ABSTRACT

Methods of operating an integrated circuit include determining a difference between a reference level and a level of a power supply voltage at a processor circuit of the integrated circuit, generating a digital code responsive to the determined difference and transmitting the digital code to a power management integrated circuit that provides power to the integrated circuit. The power management integrated circuit may adjust the power supply voltage responsive to the transmitted code. Integrated circuits and data processing systems are also provided.

### CROSS-REFERENCE TO RELATED APPLICATIONS

This application claims priority under 35 U.S.C. §119(a) from Korean Patent Application No. 10-2011-0010483 filed on Feb. 7, 2011, the disclosure of which is hereby incorporated by reference in its entirety.

### BACKGROUND

The inventive subject matter relates to power management for processor integrated circuits and, more particularly, to apparatus and methods for controlling a power supply voltage provided to a processor.

Mobile devices, such as smart phones, typically manage power in order to increase their battery life. Power management integrated circuits (PMICs) are typically used to manage power in mobile devices. Typically, a PMIC provides a power to an application processor of the mobile device, as well as to other device components, such as memory devices. When the power supply voltage drops due to overload on the application processor or the length of a power line, the application processor may stop or generate errors.

### SUMMARY

According to some embodiments of the inventive subject matter, methods of operating an integrated circuit include determining a difference between a reference level and a level of a power supply voltage at a processor circuit of the integrated circuit. A digital code is generated responsive to the determined difference and transmitted to a power management integrated circuit that provides power to the integrated circuit via, for example, a communications bus.

Determining a difference between a reference level and a level of a power supply voltage at a processor circuit of the integrated circuit may include comparing the power supply voltage to an analog reference voltage to generate an analog comparison signal. Generating a digital code responsive to the determined difference may include generating the digital code from the analog comparison signal.

Determining a difference between a reference level and a level of a power supply voltage at a processor circuit of the integrated circuit may include generating a digital power supply voltage signal from the power supply voltage and comparing the digital power supply voltage to a digital reference signal to generate a digital comparison signal. Generating a digital code responsive to the determined difference may include generating the digital code from the digital comparison signal.

In further embodiments, an integrated circuit includes a processor circuit configured to be powered by a power management integrated circuit via a power line, The integrate circuit further includes a voltage detector circuit configured to determine a difference between a reference level and a level of a power supply voltage at the processor circuit and a code generator circuit configured to generate a digital code responsive to the determined difference and to transmit the digital code to the power management integrated circuit.

In some embodiments, the voltage detector circuit may include an analog-to-digital converter circuit configured to generate a digital power supply voltage signal responsive to the power supply voltage and a digital comparator circuit configured to generate a digital comparison signal responsive to a comparison of the digital power supply voltage signal and a digital reference signal. In further embodiments, the voltage detector circuit may include a comparator circuit configured to generate an analog comparison signal responsive to a comparison of the power supply voltage to an analog reference signal. The integrated circuit may further include an I²C interface circuit configured to support communication of the digital code to the power management integrated circuit.

In additional embodiments, a data processing system includes a power management integrated circuit and a processor integrated circuit coupled to the power management integrated circuit by a power line and a communications bus. The processor integrated circuit includes a processor circuit coupled to the power line, a voltage detector circuit configured to determine a difference between a reference level and a level of a power supply voltage at the processor circuit and a code generator circuit configured to generate a digital code responsive to the determined difference and to transmit the digital code to the power management integrated circuit via the communications bus.

### BRIEF DESCRIPTION OF THE DRAWINGS

The above and other features and advantages of the inventive subject matter will become more apparent by describing in detail exemplary embodiments thereof with reference to the attached drawings in which:

FIG. 1 is a block diagram of a power management system according to some embodiments of the inventive subject matter;

FIGS. 2A and 2B are detailed block diagrams of a voltage detector illustrated in FIG. 1 according to some embodiments of the inventive subject matter;

FIG. 3 is a detailed block diagram of a power management device illustrated in FIG. 1;

FIG. 4 is a flowchart of operations of the power management system illustrated in FIG. 1,

FIG. 5 is a block diagram of a computer system including the power management system illustrated in FIG. 1 according to some embodiments of the inventive subject matter;

FIG. 6 is a block diagram of a computer system including the power management system illustrated in FIG. 1 according to some embodiments of the inventive subject matter; and

FIG. 7 is a block diagram of a computer system including the power management system illustrated in FIG. 1 according to further embodiments of the inventive subject matter.

### DETAILED DESCRIPTION OF THE EMBODIMENTS

Exemplary embodiments now will be described more fully hereinafter with reference to the accompanying drawings. The exemplary embodiments may, however, be embodied in many different forms and should not be construed as limited to the embodiments set forth herein. Rather, these embodiments are provided so that this disclosure will be thorough and complete. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

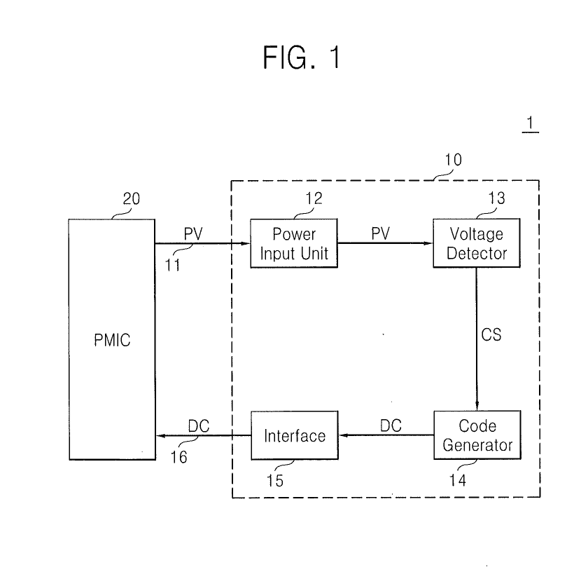

FIG. 1 is a block diagram of a power management system 1 according to some embodiments of the inventive subject matter. Referring to FIG. 1, the power management system 1 includes a processor 10 and a power management device 20 which provides a power supply voltage PV to the processor 10. The processor 10 and the power management device 20 form a data processing system.

The processor 10 may be implemented as an application processor which executes an application. The processor 10 includes a power input unit 12, a voltage detector 13, a code generator 14, and an interface 15.

The power management device 20 may be implemented as a power management integrated circuit (PMIC). The power management device 20 provides the power supply voltage PV to the power input unit 12 via a power line 11.

The processor 10 may also include a plurality of power pins for driving the processor 10 and a plurality of data pins for communicating data with an external device. The power line 11 is connected to the power input unit 12. The power input unit 12 may be connected to a power pin having the largest voltage drop among the power pins.

The voltage detector 13 detects the level of the power supply voltage PV received from the power input unit 12 and generates a detection signal. The voltage detector 13 compares the voltage level of the detection signal with the voltage level of a reference signal and generates a comparison signal CS. The voltage detector 13 transmits the comparison signal CS to the code generator 14. The comparison signal CS includes information about the drop of the power supply voltage PV, e.g., information about a difference between an output voltage of the power management device 20 and an input voltage of the power input unit 12.

For instance, when a driving voltage for driving the processor 10 normally is 1.5 V, the voltage level of the reference signal is set to 1.5 V. The power management device 20 will provide the power supply voltage PV of 1.5 V to the processor 10 via the power line 11, but the power supply voltage PV actually received by the processor 10 will be lower than 1.5 V due to voltage loss in the power line 11. In other words, when the power supply voltage PV applied to the processor 10 is lower than 1.5 V, the operation of the process 10 may stop or errors may occur in the processor 10.

To prevent the errors from occurring or the operation from stopping, the processor 10 needs to be stably provided with the power supply voltage PV from the power management device 20. To stably provide the power supply voltage PV to the processor 10, the power management device 20 needs information about the level of the power supply voltage PV input to the power input unit 12.

The code generator 14 generates a digital code DC corresponding to the comparison signal CS. The code generator 14 transmits the digital code DC to the power management device 20 via the interface 15. The digital code DC includes information about the drop of the power supply voltage PV transmitted from the power management device 20 to the processor 10. The power management device 20 may adjust the level of the power supply voltage PV according to the digital code DC.

The interface 15 includes an inter-integrated circuit (I²C) interface. I2C™ is a serial computer bus developed by Philips and is used to connect a low-speed peripheral device to, for example, a motherboard, an embedded system, or a mobile phone. The processor 10 and the power management device 20 may be integrated into a single chip to form a system-on-chip (SOC).

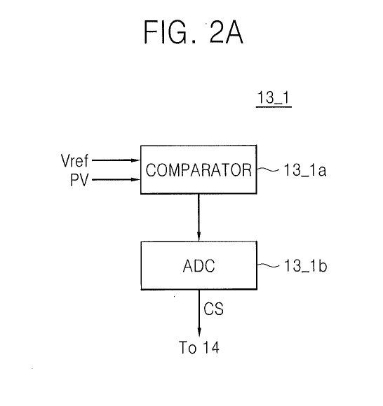

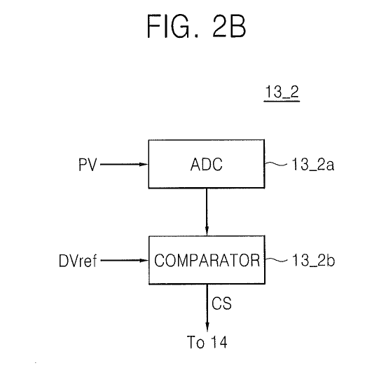

FIGS. 2A and 2B are detailed block diagrams of a voltage detector illustrated in FIG. 1 according to some embodiments of the inventive subject matter. Referring to FIGS. 1 and 2A, a voltage detector 13_1 includes a comparator 13_1a and an analog-to-digital converter (ADC) 13_1b. The comparator 13_1a detects the level of the power supply voltage PV received from the power input unit 12 and generates a detection signal. The comparator 13_1a compares the voltage level of the detection signal with the voltage level of a reference signal Vref and generates a comparison signal CS. The comparator 13_1a transmits the comparison signal CS to the ADC 13_1b. The ADC 13_1b converts the comparison signal CS into a digital value and transmits the digital value to the code generator 14.

Referring to FIGS. 1 and 2B, a voltage detector 13_2 includes an ADC 13_2a and a comparator 13_2b. The ADC 13_2a converts the power supply voltage PV into a digital value and transmits a digital power supply voltage to the comparator 13_2b. The comparator 13_2b compares the level of the digital power supply voltage with the voltage level of a digital reference signal DVref and generates a comparison signal CS. The comparison signal CS may be a digital signal corresponding to a difference between the digital power supply voltage and the digital reference signal DVref. The comparator 13_2b transmits the comparison signal CS to the code generator 14.

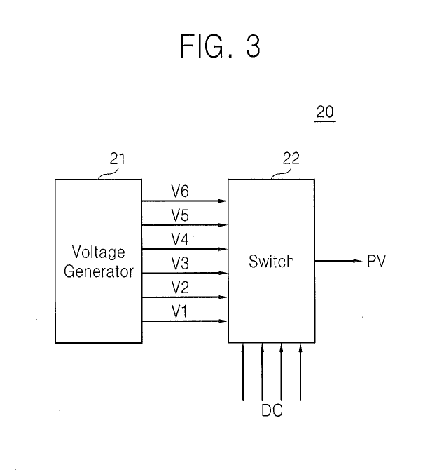

FIG. 3 is a detailed block diagram of the power management device 20 illustrated in FIG. 1, Referring to FIGS. 1 through 3, the power management device 20 includes a voltage generator 21 and a switch 22.

The voltage generator 21 generates a plurality of driving voltages V1 through V6 for driving the processor 10. When the power management system (or the data processing system) 1 is a smart phone, for example, the voltage generator 21 may be powered by a battery.

The voltage generator 21 generates the plurality of driving voltages V1 through V6 taking account of the fact that the power supply voltage PV provided to the processor 10 will drop across the power line 11. For instance, when a driving voltage of the processor 10 is 1.5 V, the voltage generator 21 may generate 1.3 V (V1), 1.4 V (V2), 1.5 V (V3), 1.6 V (V4), 1.7 V (V5), and 1.8 V (V6).

The switch 22 may select and output as the power supply voltage PV one of the driving voltages V1 through V6 output from the voltage generator 21 in response to the digital code DC output from the processor 10, For instance, when the digital code DC is 4 bits in length, the switch 22 outputs 1.5 V (V3) as the power supply voltage PV in response to the digital code DC of 1000, outputs 1.6 V (V4) as the power supply voltage PV in response to the digital code DC of 1001, and outputs 1.7 V (V5) as the power supply voltage PV in response to the digital code DC of 1010.

In other words, since the digital code DC corresponds to a difference between an output voltage of the power management device 20 and an input voltage of the power input unit 12, when the difference is 0.2 V, the switch 22 may output as the power supply voltage PV a voltage 0.2 V higher than a previous power supply voltage in response to the digital code DC instructing to increase the voltage by 0.2 V.

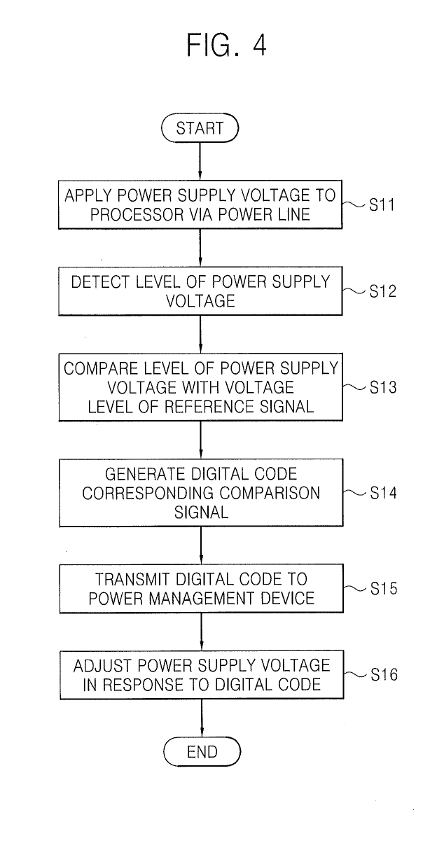

FIG. 4 is a flowchart of the operations of the power management system 1 illustrated in FIG. 1. Referring to FIGS. 1 through 4, the power management device 20 applies the power supply voltage PV to the processor 10 via the power line 11 in operation S11. The voltage detector 13 detects the level of the power supply voltage PV output form the power input unit 12 and generates a detection signal in operation S12.

The voltage detector 13 compares the detection signal with the reference signal Vref or DVref, generates the comparison signal CS, and transmits the comparison signal CS to the code generator 14 in operation S13. The code generator 14 generates the digital code DC corresponding to the comparison signal CS in operation S14. The code generator 14 feeds back the digital code DC to the power management device 20 via the interface 15 in operation S15. The power management device 20 may increase the level of the power supply voltage PV in response to the digital code DC corresponding to a voltage lost across the power line 11 and/or the power input unit 12 in operation S16.

The processor 10 transmits information about the level of the power supply voltage PV received via the power line 11 to the power management device 20 via a data (communications) bus 16 having an n-bit width (where “n” is a natural number). The information in a form of a digital value, i.e., the digital code DC is not affected by voltage drop when it is transmitted via the data bus 16. Accordingly, the power management device 20 receives the digital code DC, i.e., the information indicating the drop of the power supply voltage PV, and applies the power supply voltage PV increased by the amount of the drop to the processor 10.

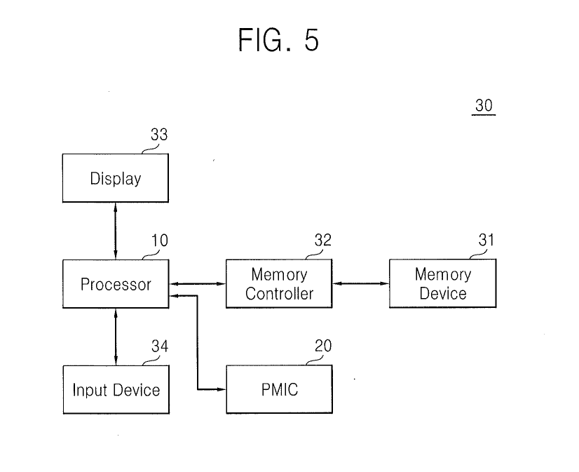

FIG. 5 is a block diagram of a computer system 30 including the processor 10 illustrated in FIG. 1 according to some embodiments of the inventive subject matter. Referring to FIG. 5, the computer system 30 including the processor 10 and the power management device 20 illustrated in FIG. 1 may be implemented as a personal computer (PC), a network server, a tablet PC, a lap-top computer, an e-reader, a personal digital assistant (PDA), a portable multimedia player (PMP), an MP3 player, or an MP4 player.

The computer system 30 includes the processor 10, the power management device 20 providing the power supply voltage PV to the processor 10, a memory device 31, a memory controller 32 controlling the data processing operation of the memory device 31, a display 33, and an input device 34.

The processor 10 may display data stored in the memory device 31 through a display 33 according to data input through the input device 34. The input device 34 may include, for example, a pointing device, such as a touch pad or a computer mouse, a keypad, or a keyboard. The processor 10 may control the overall operation of the computer system 30 and the operations of the memory controller 32.

The memory controller 32, which may control the operations of the memory device 31, may be implemented as a part of the processor 10 or as a separate chip.

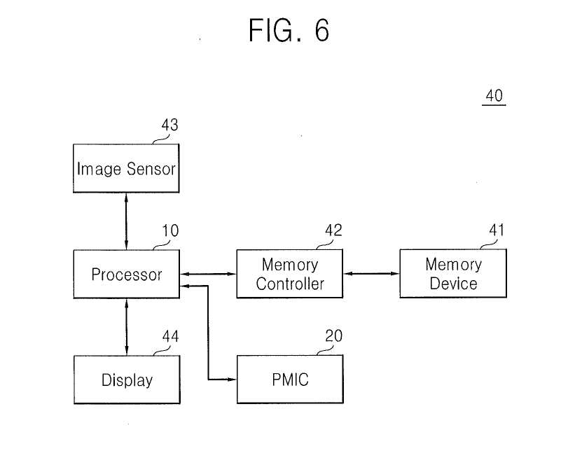

FIG. 6 is a block diagram of a computer system 40 including the processor 10 illustrated in FIG. 1 according to some embodiments of the inventive subject matter. Referring to FIG, 6, the computer system 40 including the processor 10 and the power management device 20 illustrated in FIG. 1 may be implemented as an image processing device, e.g., a digital camera, or a mobile communication device (e.g., a cellular phone or a smart phone) equipped with a digital camera.

The computer system 40 includes the processor 10; the power management device 20 applying the adjusted power supply voltage PV to the processor 10, a memory device 41, a memory controller 42 controlling the data processing operation, such as a write operation or a read operation, of the memory device 41, an image sensor 43 and a display 44.

The image sensor 43 included in the computer system 40 converts optical images into digital signals and outputs the digital signals to the processor 10 or the memory controller 42. The digital signals may be displayed through the display 44 or stored in the memory device 41 through the memory controller 42 according to the control of the processor 10.

Data stored in the memory device 41 may be displayed through the display 44 according to the control of the processor 10 or the memory controller 42.

The memory controller 42, which may control the operation of the memory device 41, may be implemented as a part of the processor 10 or as a separate chip.

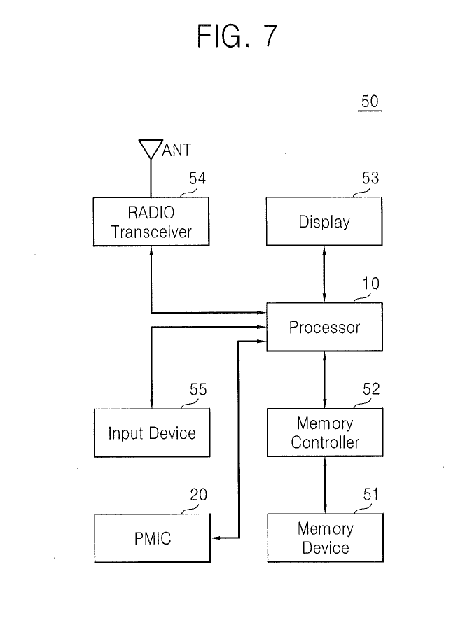

FIG. 7 is a block diagram of a computer system 50 including the processor 10 illustrated in FIG. 1 according to further embodiments of the inventive subject matter. Referring to FIG. 7, the computer system 50 including the processor 10 and the power management device 20 illustrated in FIG. 1 may be implemented as a cellular phone, a smart phone, a PDA, a smart pad, or a radio communication system. The smart pad includes a tablet PC.

The computer system 50 also includes a memory device 51 and a memory controller 52 controlling the operation of the memory device 51.

The memory controller 52 may control the data access operation, e.g., a write operation, an erase operation, or a read operation, of the memory device 51 according to the control of the processor 10. Data read from the memory device 51 may be displayed through a display 53 according to the control of the processor 10 and the memory controller 52.

A radio transceiver 54 may transmit or receive radio signals through an antenna ANT. The radio transceiver 54 may convert radio signals received through the antenna ANT into signals that can be processed by the processor 10. Accordingly, the processor 10 may process the signals output from the radio transceiver 54 and transmit the processed signals to the memory controller 52 or the display 53. The memory controller 52 may store the signals processed by the processor 10 in the memory device 51. The radio transceiver 54 may also convert signals output from the processor 10 into radio signals and outputs the radio signals to an external device through the antenna ANT.

An input device 55 enables control signals for controlling the operation of the processor 10 or data to be processed by the processor 10 to be input to the computer system 50. The input device 55 may include, for example, a pointing device, such as a touch pad or a computer mouse, a keypad, or a keyboard.

The processor 10 may control the operation of the display 53 to display data output from the memory controller 52, data output from the radio transceiver 54, or data output from the input device 55.

The memory controller 52, which controls the operation of the memory device 51, may be implemented as a part of the processor 10 or as a separate chip.

As described above, according to some embodiments of the inventive subject matter, a processor transmits digital information about the drop of a power supply voltage to a power management device via a data bus, thereby compensating for the drop of the power supply voltage.

While the inventive subject matter has been particularly shown and described with reference to exemplary embodiments thereof, it will be understood by those of ordinary skill in the art that various changes in forms and details may be made therein without departing from the spirit and scope of the inventive subject matter as defined by the following claims.

What is claimed is:

1. A method of operating an integrated circuit, the method comprising:
determining a difference between a reference level and a level of a power supply voltage at a processor circuit of the integrated circuit;
generating a digital code responsive to the determined difference; and
transmitting the digital code to a power management integrated circuit that provides power to the integrated circuit.

2. The method of claim 1:
wherein determining a difference between a reference level and a level of a power supply voltage at a processor circuit of the integrated circuit comprises comparing the power supply voltage to an analog reference voltage to generate an analog comparison signal; and
wherein generating a digital code responsive to the determined difference comprises generating the digital code from the analog comparison signal.

3. The method of claim 1:
wherein determining a difference between a reference level and a level of a power supply voltage at a processor circuit of the integrated circuit comprises:
generating a digital power supply voltage signal from the power supply voltage; and
comparing the digital power supply voltage to a digital reference signal to generate a digital comparison signal; and
wherein generating a digital code responsive to the determined difference comprises generating the digital code from the digital comparison signal.

4. The operating method of claim 2, wherein transmitting the digital code to the power management integrated circuit that provides power to the integrated circuit comprises transmitting the digital code via a communications bus.

5. An integrated circuit comprising:
a processor circuit configured to be powered by a power management integrated circuit via a power line;
a voltage detector circuit configured to determine a difference between a reference level and a level of a power supply voltage at the processor circuit; and
a code generator circuit configured to generate a digital code responsive to the determined difference and to transmit the digital code to the power management integrated circuit,

6. The integrated circuit of claim 5, wherein the voltage detector circuit comprises:
an analog-to-digital converter circuit configured to generate a digital power supply voltage signal responsive to the power supply voltage; and
a digital comparator circuit configured to generate a digital comparison signal responsive to a comparison of the digital power supply voltage signal and a digital reference signal.

7. The integrated circuit of claim 5, wherein the voltage detector circuit comprises a comparator circuit configured to generate an analog comparison signal responsive to a comparison of the power supply voltage to an analog reference signal.

8. The integrated circuit of claim 5, further comprising an I²C interface circuit configured to support communication of the digital code to the power management integrated circuit.

9. A data processing system comprising:
a power management integrated circuit; and
a processor integrated circuit coupled to the power management integrated circuit by a power line and a communications bus and comprising:
a processor circuit coupled to the power line;
a voltage detector circuit configured to determine a difference between a reference level and a level of a power supply voltage at the processor circuit; and
a code generator circuit configured to generate a digital code responsive to the determined difference and to transmit the digital code to the power management integrated circuit via the communications bus.

10. The data processing system of claim 9, wherein the voltage detector circuit comprises:
an analog-to-digital converter circuit configured to generate a digital power supply voltage signal responsive to the power supply voltage; and
a digital comparator circuit configured to generate a digital comparison signal responsive to a comparison of the digital power supply voltage signal and a digital reference signal.

11. The data processing system of claim 9, wherein the voltage detector circuit comprises a comparator circuit configured to generate an analog comparison signal responsive to a comparison of the power supply voltage to an analog reference signal.

12. The data processing system of claim 9, wherein the processor integrated circuit further comprises an I²C interface circuit configured to support communication of the digital code to the power management integrated circuit over the communications bus.

13. The data processing system of claim 9, wherein the processor integrated circuit and the power management integrated circuit are integrated in a single chip.
